(19) United States
(12) Patent Application Publication
(10) Pub. No.: US 2006/0179180 A1
(43) Pub. Date: Aug. 10, 2006

(54) Signal processing apparatus, signal processing system and signal processing method

(75) Inventors: Takami Sugita, Ome-shi (JP); Minoru Moriwaki, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/337,507

(22) Filed: Jan. 24, 2006

(30) Foreign Application Priority Data
Feb. 4, 2005 (JP) 2005-029148

(51) Int. Cl. G06F 13/28

(52) U.S. Cl. 710/22

(57) ABSTRACT

An apparatus includes a first direct memory access controller which successively processes first descriptors, thereby executing a series of data transfers for reading first data, which is stored in a memory, and generates an activation signal in a case where a current to-be-processed first descriptor of the first descriptors includes control information which instructs start of another data transfer, a second direct memory access controller which executes, each time the activation signal is received, a current to-be-processed second descriptor of second descriptors, thereby executing one of a series of data transfers for reading second data, which is stored in the memory, and an output signal generation unit that mixes the first data which is read by the first direct memory access controller and the second data which is read by the second direct memory access controller, thereby generating an output signal including the first data and the second data.

### CROSS-REFERENCE TO RELATED APPLICATIONS

This application is based upon and claims the benefit of priority from prior Japanese Patent Application No. 2005-029148, filed Feb. 4, 2005, the entire contents of which are incorporated herein by reference.

### BACKGROUND OF THE INVENTION

1. Field of the Invention

The present invention relates to a signal processing apparatus, a signal processing system and a signal processing method for generating an output signal including two kinds of data.

2. Description of the Related Art

In recent years, various signal processing systems, such as personal computers and AV (audio/video) equipment, have been developed. In these signal processing systems, direct memory access (DMA) transfer is used in order to efficiently execute transfer of a large-capacity data stream such as AV data.

Jpn. Pat. Appln. KOKAI Publication No. 2001-175585 discloses an apparatus that executes transfer of video data by using DMA transfer. This apparatus includes two DMA controllers. The two DMA controllers transfer video data, which are input from a camera, to two different memories.

As an interface standard for outputting AV data to an external device, there is known a standard in which an output signal including two kinds of data, such as audio data and its attribute data, is output to an external device.

In order to obtain an output signal including two kinds of data, it is necessary, in usual cases, to mix the two kinds of data in advance by software. In this case, however, not only the two kinds of data but also the mixed data of the two kinds of data are stored in a memory. Consequently, a large memory space is occupied. It is thus necessary to realize a novel function for generating the above-mentioned output signal without preparing mixed data in the memory.

### BRIEF SUMMARY OF THE INVENTION

According to an embodiment of the present invention, there is provided a signal processing apparatus comprising: a first direct memory access controller which successively processes a plurality of first descriptors that describe contents of data transfers to be executed, thereby executing a series of data transfers for reading first data, which is stored in a memory, by direct memory access, and generates an activation signal in a case where a current to-be-processed first descriptor of the plurality of first descriptors includes control information which instructs start of another data transfer; a second direct memory access controller which executes, each time the activation signal is received, a current to-be-processed second descriptor of a plurality of second descriptors that describe contents of data transfers to be executed, thereby executing one of a series of data transfers for reading second data, which is stored in the memory, by direct memory access; and an output signal generation unit which mixes the first data which is read by the first direct memory access controller and the second data which is read by the second direct memory access controller, thereby generating an output signal including the first data and the second data.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram that shows the structure of a signal processing system according to an embodiment of the present invention;

FIG. 2 shows the structure of a descriptor that is used in the signal processing system shown in FIG. 1;

FIG. 3 is a view for explaining a data transfer operation that is executed in the signal processing system shown in FIG. 1;

FIG. 4 shows an example of an output signal that is generated by the signal processing system shown in FIG. 1;

FIG. 5 is a block diagram that shows an example of the structure of an output signal generation unit that is provided in the signal processing system shown in FIG. 1;

FIG. 6 shows an example of a digital audio output signal that is generated by the signal processing system shown in FIG. 1;

FIG. 7 shows an example of a digital video output signal that is generated by the signal processing system shown in FIG. 1;

FIG. 8 shows an example of two transfer descriptor chains that are used in the signal processing system shown in FIG. 1;

FIG. 9 illustrates a scheme in which audio data and user data are synchronously transferred in the signal processing system shown in FIG. 1;

FIG. 10 is a flow chart illustrating the procedure of a process that is executed by a first DMA controller provided in the signal processing system shown in FIG. 1; and

FIG. 11 is a flow chart illustrating the procedure of a process that is executed by a second DMA controller provided in the signal processing system shown in FIG. 1.

### DETAILED DESCRIPTION OF THE INVENTION

An embodiment of the present invention will now be described with reference to the accompanying drawings.

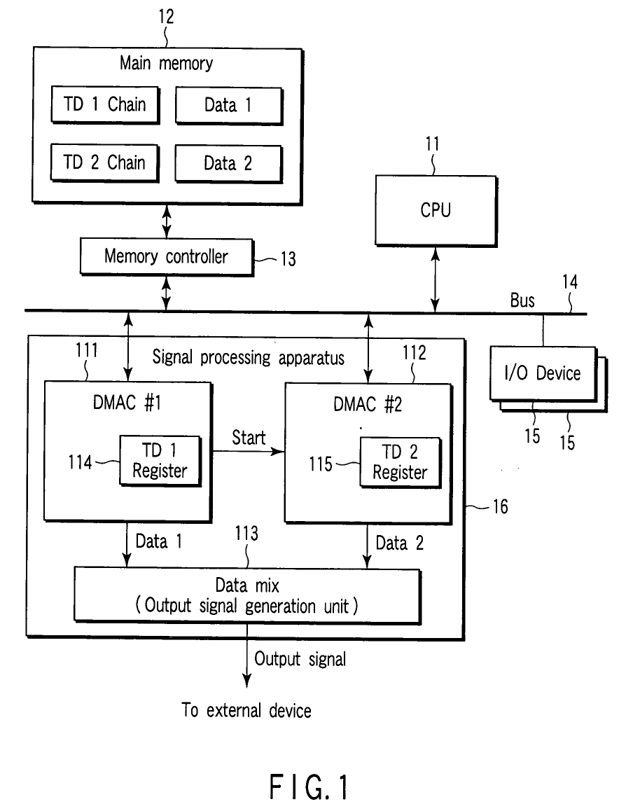

FIG. 1 shows an example of the structure of a signal processing system according to an embodiment of the invention. The signal processing system is a system that handles digital signals, and is realized, for instance, as a personal computer, AV equipment, etc.

The signal processing system comprises a CPU (Central Processing Unit) 11, a main memory 12, a memory controller 13, a plurality of I/O devices 15, and a signal processing apparatus 16. These components are connected to a bus 14. The I/O devices 15 include, for instance, a hard disk drive and a USB (Universal Serial Bus) controller.

The CPU 11 is a processor that executes various data processes, and controls the operation of the signal processing system. The main memory 12 is a memory device that stores programs, which are executed by the CPU 11, and data which is processed by the CPU 11. The memory controller 13 access-controls the main memory 12.

The signal processing apparatus 16 is a device that generates, from two kinds of data (main data Data 1, sub-data Data 2) that are stored in the main memory 12, an output signal that includes these two kinds of data (main data Data 1, sub-data Data 2). The sub-data (Data 2) is the data that is used as auxiliary data accompanying the main data (Data 1). The output signal is composed of a digital data string of a predetermined format, which includes the main data (Data 1) and sub-data (Data 2). The signal processing apparatus 16 reads out the main data (Data 1) and sub-data (Data 2) synchronously from the main memory 12, and generates the output signal by combining the read-out main data (Data 1) and sub-data (Data 2).

The signal processing apparatus 16, as shown in FIG. 1, comprises a first DMA controller (DMAC #1) 111, a second DMA controller (DMAC #2) 112, and a data mixer circuit (Data Mix) 113.

The first DMA controller (DMAC #1) 111 is a direct memory access controller that executes a so-called descriptor-based DMA transfer (descriptor-based DMA). The first DMA controller (DMAC #1) 111 executes DMA transfer according to a transfer descriptor (hereafter also referred to simply as “descriptor”). Specifically, the DMA transfer by the first DMA controller (DMAC #1) 111 is executed in accordance with first transfer descriptor chain information (TD1 Chain) that is stored in the main memory 12 by the CPU 11. The first transfer descriptor chain information (TD1 Chain) is information that describes the content of a plurality of data transfers to be executed, and is composed of a plurality of transfer descriptors that describe the contents of the plural data transfers, respectively.

The first DMA controller (DMAC #1) 111 successively processes the plural transfer descriptors included in the first transfer descriptor chain information (TD1 Chain), thereby executing a series of data transfers for reading by DMA the main data (Data 1) which is stored in the main memory 12.

The first DMA controller (DMAC #1) 111 includes a register (TD1 register) 114 that stores a current transfer descriptor that is a to-be-processed object. The first DMA controller (DMAC #1) 111 reads out a first transfer descriptor in the first transfer descriptor chain information (TD1 Chain) from the main memory 12, and stores the read-out first transfer descriptor in the register (TD1 register) 114. The first DMA controller (DMAC #1) 111 executes data transfer that is designated by the transfer descriptor stored in the register (TD1 register) 114. Upon completion of this data transfer, the first DMA controller (DMAC #1) 111 reads out the next transfer descriptor in the first transfer descriptor chain information (TD1 Chain) from the main memory 12, and stores the read-out transfer descriptor in the register (TD1 register) 114. The first DMA controller (DMAC #1) 111 executes data transfer that is designated by the transfer descriptor stored in the register (TD1 register) 114. In this manner, the first DMA controller (DMAC #1) 111 successively executes a series of data transfers for reading by DMA the main data (Data 1), which is stored in the main memory 12. Since the series of data transfers for reading the main data (Data 1) are automatically executed by the DMA controller (DMAC #1) 111, the CPU 11 can execute another process while the transfer process of the main data (Data 1) is being executed.

Further, the first DMA controller (DMAC #1) 111 has a function of generating an activation signal START for activating the second DMA controller (DMAC #2) 112. The activation signal START is generated when a flag is set in the current transfer descriptor that is stored in the register (TD1 register) 114. This flag is control information indicating that DMA transfer of the second DMA controller (DMAC #2) 112 is to be started.

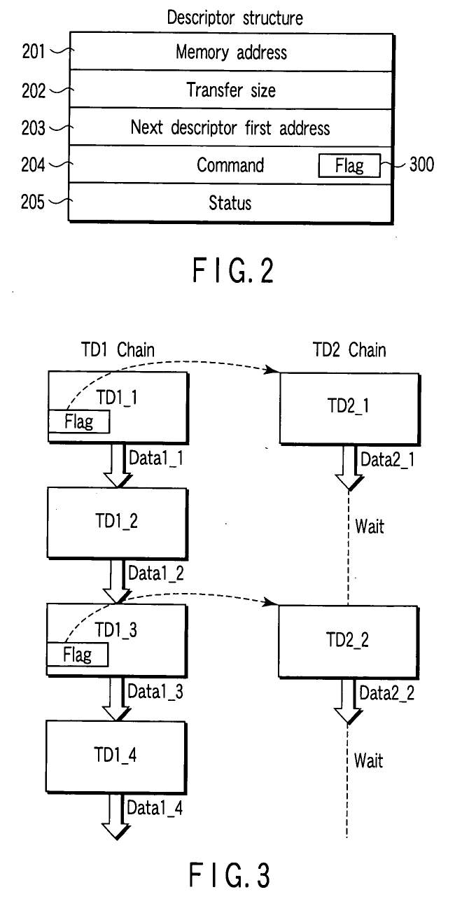

FIG. 2 shows an example of the structure of the transfer descriptor. Each transfer descriptor is information that describes the content of a data transfer to be executed. Each transfer descriptor comprises a memory address field 201, a transfer size field 202, a next descriptor first address field 203, a command field 204 and a status field 205.

The memory address field 201 includes a memory address that indicates a first address of a memory area where to-be-transferred data is stored. The transfer size field 202 includes size information that indicates a data size of to-be-transferred data. The next descriptor first address field 203 includes a pointer that indicates a first address of a memory area where a transfer descriptor, which is to be next processed, is stored. The command field 204 includes a command that designates, e.g. contents of various option processes which are to be executed in the process of the current transfer descriptor.

This command includes, for instance, a parameter that designates the kind of a bus cycle (e.g. burst read transfer, single read transfer) which is to be used for data transfer, and a parameter that designates whether an interrupt signal is to be generated to the CPU 11 after completion of data transfer.

In the present embodiment, a flag field 300 for describing the above-mentioned flag (FLAG) is defined in a part of the area in the command field 204. In the case where the flag (FLAG) is set in the flag field 300 (FLAG=“1”), the first DMA controller (DMAC #1) 111 generates an activation signal START to activate the second DMA controller (DMAC #2) 112.

The status field 205 is a field in which a transfer result status, which indicates, e.g. completion of transfer, is written. When data transfer corresponding to the current to-be-processed transfer descriptor is completed, the first DMA controller (DMAC #1) 111 writes a transfer result status, which indicates completion of transfer, in the status field 205 in the current transfer descriptor in the main memory 12.

The second DMA controller (DMAC #2) 112 is also a direct memory access controller that executes a so-called descriptor-based DMA transfer (descriptor-based DMA). The second DMA controller (DMAC #2) 112 executes DMA transfer in accordance with second transfer descriptor chain information (TD2 Chain) that is stored in the main memory 12 by the CPU 11. The second transfer descriptor chain information (TD2 Chain) is information that describes the content of a plurality of data transfers to be executed, and is composed of a plurality of transfer descriptors that describe the contents of the plural data transfers, respectively.

Each time the second DMA controller (DMAC #2) 112 receives an activation signal START from the first DMA controller (DMAC #1) 111, the second DMA controller (DMAC #2) 112 processes a current to-be-processed transfer descriptor in the second transfer descriptor chain information (TD2 Chain), thereby executing, by DMA, one of a series of data transfers for reading the sub-data (Data 2), which is stored in the main memory 12.

The second DMA controller (DMAC #2) 112 includes a register (TD2 register) 115 that stores a current transfer descriptor that is a to-be-processed object. Upon receiving the activation signal START, the second DMA controller (DMAC #2) 112 reads out a first transfer descriptor in the second transfer descriptor chain information (TD2 Chain) and stores the read-out first transfer descriptor in the register (TD2 register) 115. The second DMA controller (DMAC #2) 112 executes data transfer that is designated by the transfer descriptor stored in the register (TD2 register) 115. Upon completion of this data transfer, the second DMA controller (DMAC #2) 112 is in a wait state (Wait) until it receives the next activation signal START. If the second DMA controller (DMAC #2) 112 receives the next activation signal START, the second DMA controller (DMAC #2) 112 reads out the next transfer descriptor from the main memory 12 and stores it in the register (TD2 register) 115. The second DMA controller (DMAC #2) 112 executes data transfer that is designated by the transfer descriptor stored in the register (TD2 register) 115. In this manner, each time the second DMA controller (DMAC #2) 112 receives the activation signal START, it executes a single data transfer.

Each transfer descriptor in the second transfer descriptor chain information (TD2 Chain), as shown in FIG. 2, similarly comprises the memory address field 201, transfer size field 202, next descriptor first address field 203, command field 204 and status field 205. However, it is not necessary to define a field for describing the above-described flag (FLAG) in the command field 204.

The data mixer circuit (Data Mix) 113 is an output signal generation unit that mixes the main data (Data 1), which is read by the first DMA controller (DMAC #1) 111, and the sub-data (Data 2), which is read by the second DMA controller (DMAC #2) 112, thereby generating an output signal of a predetermined format including the main data (Data 1) and sub-data (Data 2). The output signal is composed of a digital data string in which the main data (Data 1) and sub-data (Data 2) are multiplexed.

In the digital data string, the main data (Data 1) and sub-data (Data 2) are alternately arranged, for example, in unit data strings. Each unit data string comprises a partial data string of the main data (Data 1) of a fixed data length, and a partial data string of the sub-data (Data 2), which corresponds to the partial data string of the main data (Data 1). In usual cases, the data length of the partial data string of the sub-data (Data 2) is less than the data length of the partial data string of the main data (Data 1).

The partial data string of the main data (Data 1), which is to be included in each unit data string, can be read out from the main memory 12 by a single or plural successive DMA transfers, which are executed by the first DMA controller (DMAC #1) 111. On the other hand, the partial data string of the sub-data (Data 2), which is to be included in each unit data string, can be read out from the main memory 12 by a single DMA transfer, which is executed by the second DMA controller (DMAC #2) 112. Thus, the frequency of execution of DMA transfer of the sub-data (Data 2) may be less than that of execution of DMA transfer of the main data (Data 1), and the transfer data size of the sub-data (Data 2), which is transferred by a single DMA transfer, may be less than that of the main data (Data 1).

In the present embodiment, the transfer timing of the sub-data (Data 2) is controlled by the content of the flag field that is included in each transfer descriptor in the first transfer descriptor chain (TD1 Chain). Thus, in sync with the transfer of a partial data string in the main data (Data 1), the partial data string of the sub-data (Data 2), which corresponds to the partial data string in the main data (Data 1), can be transferred. Therefore, without providing a large-capacity working buffer in the data mixer circuit (Data Mix) 113, the data mixer circuit (Data Mix) 113 can easily generate the above-mentioned output signal by simply combining the partial data string of the main data (Data 1) and the partial data string of the sub-data (Data 2), which are synchronously transferred from different memory areas of the main memory 12.

Next, referring to FIG. 3, a description is given of the transfer operation of main data (Data 1) and sub-data (Data 2), which is executed by the signal processing apparatus 16.

Assume now that the first transfer descriptor chain (TD1 Chain), which describes the content of data transfer relating to the main data (Data 1), comprises transfer descriptors TD1_1, TD1_2, TD1_3, TD1_4, and the second transfer descriptor chain (TD2 Chain), which describes the content of data transfer relating to the sub-data (Data 2), comprises transfer descriptors TD2_1, TD2_2, .In addition, assume that flags are set in the transfer descriptors TD1_1 and TD1_3, and no flag is set in the transfer descriptors TD1_2 and TD1_4. The first transfer descriptor chain (TD1 Chain) and second transfer descriptor chain (TD2 Chain) are generated by the CPU 11 and stored in the main memory 12.

The CPU 11 informs the first DMA controller (DMAC #1) 111 of a memory address indicative of a storage position of the first transfer descriptor TD1_1 of the first transfer descriptor chain (TD1 Chain), and informs the second DMA controller (DMAC #2) 112 of a memory address indicative of a storage position of the first transfer descriptor TD2_1 of the second transfer descriptor chain (TD2 Chain). Then, the CPU 11 instructs the first DMA controller (DMAC #1) 111 to start data transfer.

Responding to the data transfer start instruction from the CPU 11, the first DMA controller (DMAC #1) 111 reads out the current to-be-processed transfer descriptor, i.e. descriptor TD1_1, from the main memory 12, and stores it in the register 114. The second DMA controller (DMAC #2) 112 waits until receiving an activation signal START from the first DMA controller (DMAC #1) 111.

The first DMA controller (DMAC #1) 111 starts processing of the descriptor TD1_1. Since the flag is set in the descriptor TD1_1, the first DMA controller (DMAC #1) 111 generates an activation signal START, instructs the second DMA controller (DMAC #2) 112 to start DMA transfer, and starts data transfer to read out partial data (Data 1_1) of the main data (Data 1), which is designated by the descriptor TD1_1, from the main memory 12 by DMA.

Upon receiving the activation signal START, the second DMA controller (DMAC #2) 112 reads out the current to-be-processed transfer descriptor, i.e. descriptor TD2_1, from the main memory 12, and stores it in the register 115. The second DMA controller (DMAC #2) 112 starts processing of the descriptor TD2_1. Specifically, the second DMA controller (DMAC #2) 112 executes data transfer to read out partial data (Data 2_1) of the sub-data (Data 2), which is designated by the descriptor TD2_1, from the main memory 12 by DMA. Upon completion of the transfer of the data (Data 2_1), the second DMA controller (DMAC #2) 112 transits to the wait state once again.

If the first DMA controller (DMAC #1) 111 completes the transfer of the data (Data 1_1) that is designated by the current descriptor TD1_1, it reads out of the main memory 12 the next transfer descriptor TD1_2 that is designated by the next descriptor first address field 203 in the descriptor TD1_1, and stores the read-out transfer descriptor TD1_2 in the register 114. The first DMA controller (DMAC #1) 111 starts processing of the transfer descriptor TD1_2. Since no flag is set in the descriptor TD1_2, the first DMA controller (DMAC #1) 111 does not generate an activation signal START. The first DMA controller (DMAC #1) 111 executes data transfer to read out partial data (Data 1_2) of the main data (Data 1), which is designated by the current transfer descriptor TD1_2, from the main memory 12 by DMA.

If the first DMA controller (DMAC #1) 111 completes the transfer of the data (Data 1_2) that is designated by the transfer descriptor TD1_2, it reads out of the main memory 12 the next transfer descriptor TD1_3 that is designated by the next descriptor first address field 203 in the descriptor TD1_2, and stores the read-out transfer descriptor TD1_3 in the register 114. The first DMA controller (DMAC #1) 111 starts processing of the transfer descriptor TD1_3.

Since the flag is set in the descriptor TD1_3, the first DMA controller (DMAC #1) 111 generates an activation signal START, instructs the second DMA controller (DMAC #2) 112 to start DMA transfer, and starts data transfer to read out partial data (Data 1_3) of the main data (Data 1), which is designated by the descriptor TD1_3, from the main memory 12 by DMA.

Upon receiving the activation signal START, the second DMA controller (DMAC #2) 112 reads out the next transfer descriptor TD2_2, which is designated by the next descriptor first address field 203 in the descriptor TD2_1, from the main memory 12, and stores it in the register 115. The second DMA controller (DMAC #2) 112 starts processing of the descriptor TD2_2, and executes data transfer to read out partial data (Data 2_2) of the sub-data (Data 2), which is designated by the descriptor TD2_2, from the main memory 12 by DMA. Upon completion of the transfer of the data (Data 2_2), the second DMA controller (DMAC #2) 112 transits to the wait state once again.

If the first DMA controller (DMAC #1) 111 completes the transfer of the data (Data 1_3) that is designated by the transfer descriptor TD1_3, it reads out of the main memory 12 the next transfer descriptor TD1_4 that is designated by the next descriptor first address field 203 in the transfer descriptor TD1_3, and stores the read-out transfer descriptor TD1_4 in the register 114. The first DMA controller (DMAC #1) 111 starts processing of the transfer descriptor TD1_4. Since no flag is set in the descriptor TD1_4, the first DMA controller (DMAC #1) 111 does not generate an activation signal START. The first DMA controller (DMAC #1) 111 executes data transfer to read out partial data (Data 1_4) of the main data (Data 1), which is designated by the transfer descriptor TD1_4, from the main memory 12 by DMA.

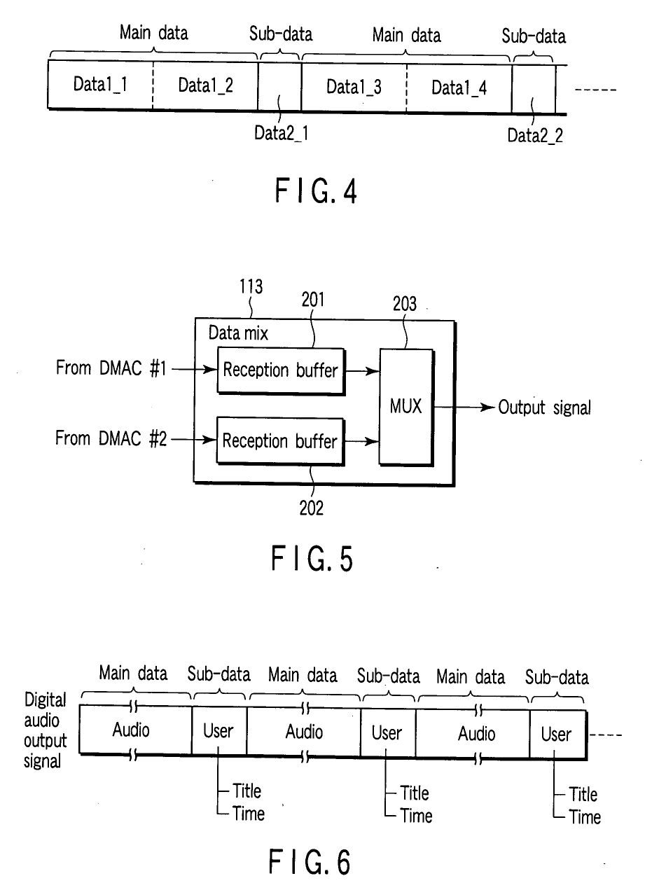

FIG. 4 shows an example of the output signal that is generated by the data mixer circuit (Data Mix) 113.

In the output signal shown in FIG. 4, a first unit data string comprises two partial data strings Data 1_1 and Data 1_2, which are read out of the main memory 12 by two DMA transfer operations that are executed by the first DMA controller (DMAC #1) 111, and one partial data string Data 2_1, which is read out of the main memory 12 by a single DMA transfer operation that is executed by the second DMA controller (DMAC #2) 112. A second unit data string comprises two partial data strings Data 1_3 and Data 1_4, which are read out of the main memory 12 by two DMA transfer operations that are executed by the first DMA controller (DMAC #1) 111, and one partial data string Data 2_2, which is read out of the main memory 12 by a single DMA transfer operation that is executed by the second DMA controller (DMAC #2) 112.

The partial data string of the sub-data may be commonly used by two successive unit data strings. In this case, for example, the first unit data string comprises the partial data string Data 1_1, which is read out of the main memory 12 by a single DMA transfer operation that is executed by the first DMA controller (DMAC #1) 111, and the partial data string Data 2_1, which is read out of the main memory 12 by a single DMA transfer operation that is executed by the second DMA controller (DMAC #2) 112. The second unit data string comprises the partial data string Data 1_2, which is read out of the main memory 12 by a single DMA transfer operation that is executed by the first DMA controller (DMAC #1) 111, and the partial data string Data 2_1, which is used in the first unit data string.

FIG. 5 shows an example of the structure of the data mixer circuit (Data Mix) 113. The data that is transferred from the main memory 12 by the first DMA controller (DMAC #1) 111 is stored in a reception buffer 201. The data that is transferred from the main memory 12 by the second DMA controller (DMAC #2) 112 is stored in a reception buffer 202. A multiplexer 203, for example, alternately reads out main data stored in the reception buffer 201 and sub-data stored in the reception buffer 202, thereby generating an output signal in which the main data and sub-data are multiplexed.

Next, specific examples of the output signal are described. The output signal is used, for instance, as a digital audio output signal or a digital video output signal.

FIG. 6 shows an example the format of a digital audio output signal that is output from the signal processing apparatus 16. In the digital audio output signal, the main data is composed of audio data, and the sub-data is composed of user data. The user data is attribute data relating to the audio data.

For example, the user data includes at least one of title information, lyrics information and time information indicative of an elapsed time from the start of reproduction, which all relate to the audio data. A unit data string comprises an audio data string for a predetermined reproduction time (e.g. 1 or more audio frames) and user data corresponding to the audio data string. An example of the format standard of the digital audio output signal is IEC60958.

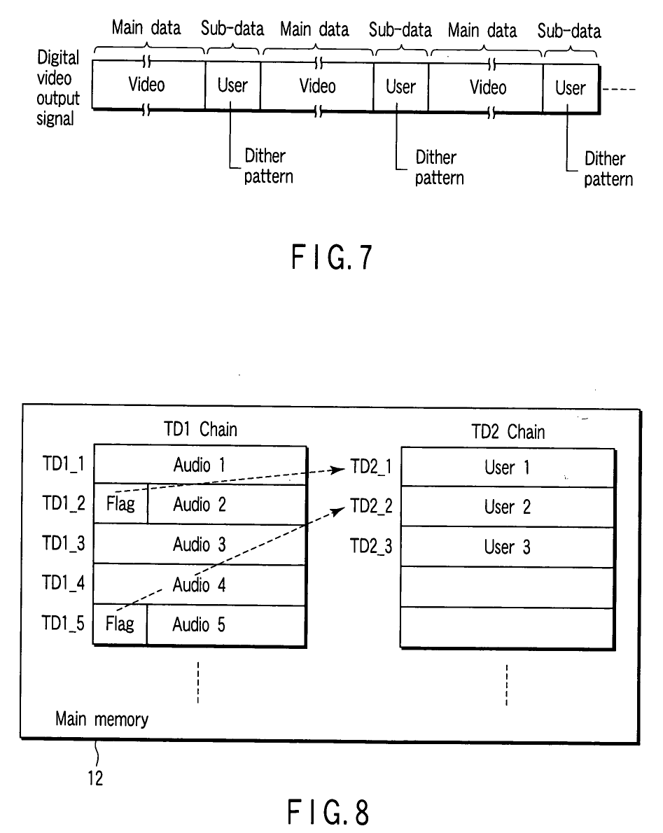

FIG. 7 shows an example the format of a digital video output signal that is output from the signal processing apparatus 16. In the digital video output signal, the main data is composed of video data, and the sub-data is composed of user data. The user data is attribute data relating to the video data. The user data includes, e.g. dither pattern information for controlling a gradation value of luminance of video data. A unit data string comprises a video data string for, e.g. one frame, and dither pattern information corresponding to the video data string.

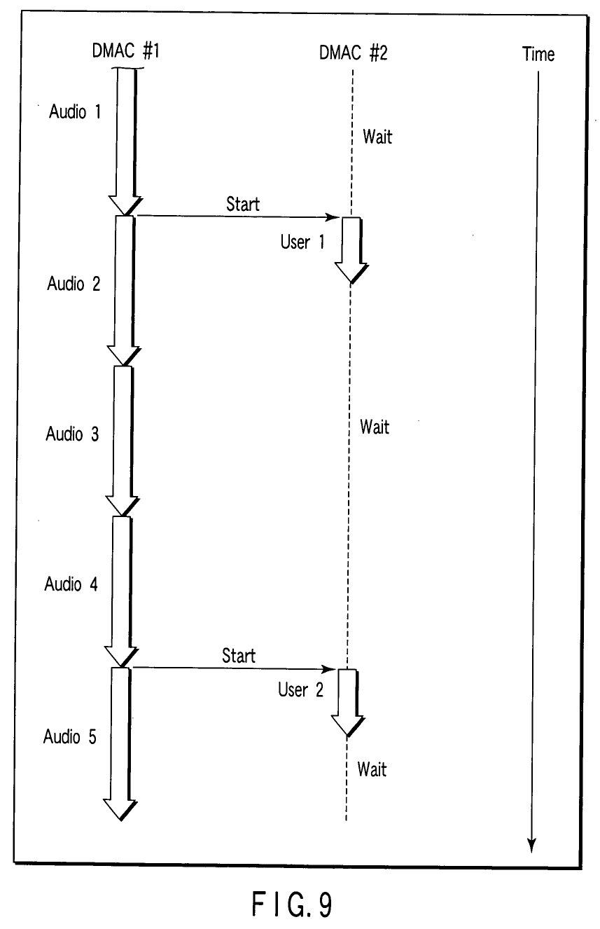

Next, referring to FIG. 8 and FIG. 9, a description is given of the operation in the case of generating a digital audio output signal from audio data (main data) and user data (sub-data) that are stored in different memory areas in the main memory 12.

FIG. 8 shows an example of description contents of the first transfer descriptor chain information (TD1 Chain) and second transfer descriptor chain information (TD2 Chain).

The first transfer descriptor chain information (TD1 Chain) comprises transfer descriptors TD1_1, TD1_2, TD1_3, TD1_4, TD1_5, . . . , which describe content of transfer of audio data. The audio data comprises a plurality of partial audio data AUDIO 1, AUDIO 2, AUDIO 3, AUDIO 4, AUDIO 5 . . . . The transfer descriptors TD1_1, TD1_2, TD1_3, TD1_4, TD1_5, . . . , include information for instructing transfer of the partial audio data AUDIO 1, AUDIO 2, AUDIO 3, AUDIO 4, AUDIO 5, . . . . Flags are set in the transfer descriptors TD1_2 and TD1_5.

The second transfer descriptor chain information (TD2 Chain) comprises transfer descriptors TD2_1, TD2_2, TD2_3, . . . , which describe content of transfer of user data. The user data comprises a plurality of partial user data USER 1, USER 2, USER 3, . . . . The transfer descriptors TD2_1, TD2_2, TD2_3, . . . , include information for instructing transfer of the partial user data USER 1, USER 2, USER 3, . . . .

In this case, in sync with the transfer of the audio data AUDIO 2, the transfer of the partial user data USER 1 is executed. In addition, in sync with the transfer of the audio data AUDIO 5, the transfer of the partial user data USER 2 is executed.

FIG. 9 illustrates the scheme of this data transfer.

The first DMA controller (DMAC #1) 111 successively processes the transfer descriptors TD1_1, TD1_2, TD1_3, TD1_4, TD1_5, . . . , and executes a series of data transfers to read the partial audio data AUDIO 1, AUDIO 2, AUDIO 3, AUDIO 4, AUDIO 5, . . . . In this case, when the transfer of the partial audio data AUDIO 2 is started, the first DMA controller (DMAC #1) 111 generates the activation signal START. Responding to the activation signal START, the second DMA controller (DMAC #2) 112 processes the transfer descriptor TD2_1 and executes data transfer for reading the partial user data USER 1. Similarly, when the transfer of the partial audio data AUDIO 5 is started, the first DMA controller (DMAC #1) 111 generates the activation signal START. Responding to the activation signal START, the second DMA controller (DMAC #2) 112 processes the transfer descriptor TD2_2 and executes data transfer for reading the partial user data USER 2.

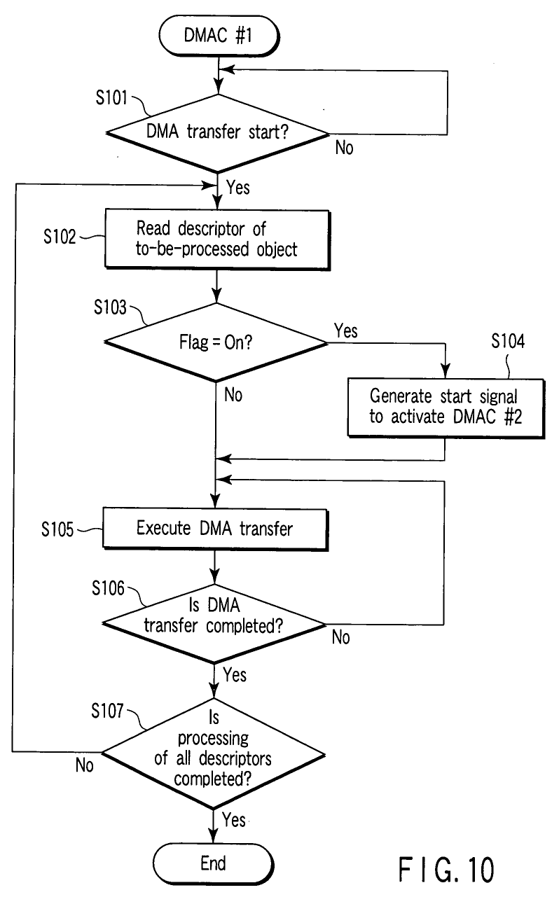

Next, referring to a flow chart of FIG. 10, the procedure of the process that is executed by the first DMA controller (DMAC #1) 111 is described.

Upon receiving a transfer start instruction from the CPU 11 (YES in step S101), the first DMA controller (DMAC #1) 111 reads out a to-be-processed transfer descriptor in the first transfer descriptor chain information (TD1 Chain) from the main memory 12, and stores it in the register 114 (step S102). The first DMA controller (DMAC #1) 111 checks the current transfer descriptor in the register 114, and determines whether the current transfer descriptor includes control information that instructs activation of the second DMA controller (DMAC #2) 112, that is, whether a flag is set in the current transfer descriptor (step S103).

If the flag is set in the current transfer descriptor (YES in step S103), the first DMA controller (DMAC #1) 111 generates the activation start signal START and instructs the second DMA controller (DMAC #2) 112 to start DMA transfer (step S104). On the other hand, if the flag is not set in the current transfer descriptor (NO in step S103), the process of step S104 is skipped.

The first DMA controller (DMAC #1) 111 starts data transfer to read by DMA the main data that is designated by the current transfer descriptor (step S105). Upon completion of this data transfer (YES in step S106), the first DMA controller (DMAC #1) 111 determines whether the processing of all transfer descriptors in the first transfer descriptor chain information (TD1 Chain) is completed (step S107). If the processing of all transfer descriptors is not completed, that is, if there is a transfer descriptor to be processed (NO in step S107), the first DMA controller (DMAC #1) 111 executes the above-described process of steps S102 to S106 for the transfer descriptor that is to be next processed. In this manner, all the transfer descriptors in the first transfer descriptor chain information (TD1 Chain) are successively processed.

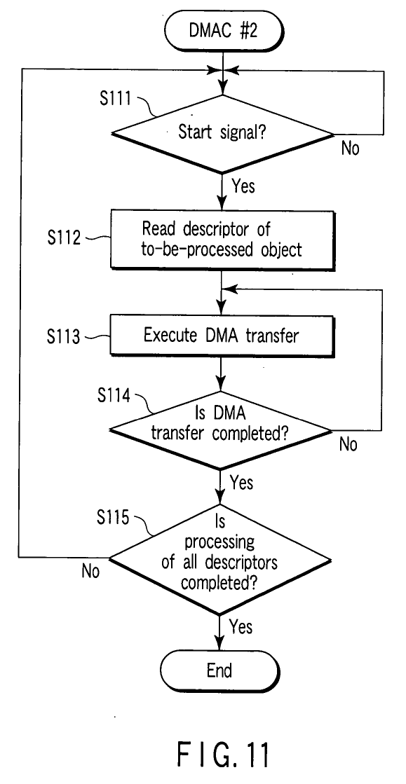

Next, referring to a flow chart of FIG. 11, the procedure of the process that is executed by the second DMA controller (DMAC #2) 112 is described.

The second DMA controller (DMAC #2) 112 waits for generation of an activation signal START from the first DMA controller (DMAC #1) 111. If the second DMA controller (DMAC #2) 112 receives the activation signal START (YES in step S111), it reads out a to-be-processed transfer descriptor in the second transfer descriptor chain information (TD2 Chain) from the main memory 12, and stores it in the register 115 (step S112). The second DMA controller (DMAC #2) 112 processes the current transfer descriptor in the register 115 and starts data transfer to read by DMA the sub-data that is designated by the current transfer descriptor (step S113). Upon completion of this data transfer (YES in step S114), the second DMA controller (DMAC #2) 112 determines whether the processing of all transfer descriptors in the second transfer descriptor chain information (TD2 Chain) is completed (step S115). If the processing of all transfer descriptors is not completed, that is, if there is a transfer descriptor to be processed (NO in step S115), the second DMA controller (DMAC #2) 112 waits for generation of the next activation signal START. Upon receiving the activation signal START (YES in step S111), the second DMA controller (DMAC #2) 112 executes the above-described process of steps S112 to S114 for the transfer descriptor that is to be next processed. In this manner, each time the second DMA controller (DMAC #2) 112 receives the activation signal START, it processes one of the transfer descriptors in the second transfer descriptor chain information (TD2 Chain).

As has been described above, in the present embodiment, two kinds of data (main data and sub-data), which are stored in different areas in the main memory 12, are synchronously read out by the two DMA controllers 111 and 112. Thus, an output signal including the two kinds of data can easily be generated. In this case, the activation timing of the DMA controller 112 is controlled by the content of the flag field that is included in each of the transfer descriptors which are successively processed by the DMA controller 111. Therefore, under the control of software, the DMA transfer operations of the two DMA controllers 111 and 112 can easily be synchronized.

In the present embodiment, the first transfer descriptor chain information (TD1 Chain) and second transfer descriptor chain information (TD2 Chain) are stored in the main memory 12. Alternatively, in a case where a working memory is provided in the signal processing apparatus 16, the first transfer descriptor chain information (TD1 Chain) and second transfer descriptor chain information (TD2 Chain) may be stored in the working memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal processing apparatus comprising:
a first direct memory access controller which successively processes a plurality of first descriptors that describe contents of data transfers to be executed, thereby executing a series of data transfers for reading first data, which is stored in a memory, by direct memory access, and generates an activation signal in a case where a current to-be-processed first descriptor of the plurality of first descriptors includes control information which instructs start of another data transfer;
a second direct memory access controller which executes, each time the activation signal is received, a current to-be-processed second descriptor of a plurality of second descriptors that describe contents of data transfers to be executed, thereby executing one of a series of data transfers for reading second data, which is stored in the memory, by direct memory access; and
an output signal generation unit which mixes the first data which is read by the first direct memory access controller and the second data which is read by the second direct memory access controller, thereby generating an output signal including the first data and the second data.

2. The signal processing apparatus according to claim 1, wherein the output signal comprises a data string in which the first data and the second data are multiplexed.

3. The signal processing apparatus according to claim 1, wherein the output signal generation unit is configured to mix a partial data string of the first data, which is read out of the memory by one or more successive data transfers by the first direct memory access controller, and a partial data string of the second data, which is read out of the memory by a single data transfer by the second direct memory access controller, thereby multiplexing the first data and the second data.

4. The signal processing apparatus according to claim 1, wherein the plurality of first descriptors and the plurality of second descriptors are stored in the memory, and
the first direct memory access controller reads the current to-be-processed first descriptor from the memory, and the second direct memory access controller reads the current to-be-processed second descriptor from the memory.

5. The signal processing apparatus according to claim 1, wherein the first data is audio data and the second data is attribute data relating to the audio data.

6. The signal processing apparatus according to claim 1, wherein the first data is video data and the second data is dither pattern information for controlling a gradation value of luminance of the video data.

7. A signal processing system comprising:
a processor which executes various data processes;
a memory which stores first data, second data that is to be output in association with the first data, a plurality of first descriptors that describe contents of data transfers relating to the first data, and a plurality of second descriptors that describe contents of data transfers relating to the second data;
a first direct memory access controller which successively processes, in response to a data transfer start instruction from the processor, the plurality of first descriptors, thereby executing a series of data transfers for reading the first data, which is stored in the memory, by direct memory access, and generates an activation signal in a case where a current to-be-processed first descriptor of the plurality of first descriptors includes control information which instructs start of another data transfer;
a second direct memory access controller which executes, each time the activation signal is received, a current to-be-processed second descriptor of the plurality of second descriptors, thereby executing one of a series of data transfers for reading the second data, which is stored in the memory, by direct memory access; and
an output signal generation unit which is connected to the first direct memory access controller and the second direct memory access controller and mixes the first data which is read by the first direct memory access controller and the second data which is read by the second direct memory access controller, thereby generating an output signal including the first data and the second data.

8. The signal processing system according to claim 7, wherein the output signal comprises a data string in which the first data and the second data are multiplexed.

9. The signal processing system according to claim 7, wherein the output signal generation unit is configured to mix a partial data string of the first data, which is read out of the memory by one or more successive data transfers by the first direct memory access controller, and a partial data string of the second data, which is read out of the memory by a single data transfer by the second direct memory access controller, thereby multiplexing the first data and the second data.

10. A signal processing method which processes first data and second data that are stored in a memory, comprising:
successively processing a plurality of first descriptors that describe contents of data transfers to be executed, thereby executing a series of first data transfers for reading the first data, which is stored in the memory, by direct memory access;
generating an activation signal in a case where a current to-be-processed first descriptor of the plurality of first descriptors includes control information which instructs start of another data transfer;
executing, each time the activation signal is received, a current to-be-processed second descriptor of a plurality of second descriptors that describe contents of data transfers to be executed, thereby executing one of a series of second data transfers for reading the second data, which is stored in the memory, by direct memory access; and
mixing the first data which is read out of the memory and the second data which is read out of the memory, thereby generating an output signal including the first data and the second data.

11. The signal processing method according to claim 10, wherein said mixing includes mixing a partial data string of the first data, which is read out of the memory by one or more successive said first data transfers, and a partial data string of the second data, which is read out of the memory by single said second data transfer, thereby multiplexing the first data and the second data.

12. The signal processing method according to claim 10, wherein the plurality of first descriptors and the plurality of second descriptors are stored in the memory, and
the current to-be-processed first descriptor is read out of the memory, and the current to-be-processed second descriptor is read out of the memory.
